(19) United States
(12) Patent Application Publication
(10) Pub. No.: US 2004/0088356 A1
(43) Pub. Date: May 6, 2004

(54) Remote worker's display device

(75) Inventors: Abigail Jane Sellen, Newbury (GB); Christopher Tofts, Acton (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/603,456

(22) Filed: Jun. 24, 2003

(30) Foreign Application Priority Data
Oct. 30, 2002 (GB) 0225307.8

(51) Int. Cl. G06F 15/16

(52) U.S. Cl. 709/205; 709/206

(57) ABSTRACT

A device for positioning in the workplace of a worker, the device being operable, in the worker's absence from said workplace, to provide a visitor to the workplace with information specifying the remote location of the worker and to enable the visitor to communicate with the absent worker; the device comprising processing means, memory, a digital display and a user interface; the processing means being coupled to a database, the database comprising data representative of a remote location and corresponding data representative of at least one possible mode of communication between the device and the remote worker at the said remote location; the processing means being electrically coupled to the digital display and the user interface; the memory being operable to store data specifying the remote location of the worker; the digital display being operable to display information specifying the remote location of the worker; the processing means being operable to interrogate the database to obtain the possible modes of communication corresponding to the said specified remote location of the worker, and then to cause the said modes of communication to be displayed for selection by the visitor; the user interface being operable to enable a visitor to select a mode of communication; and the processing means being configured to effect communication with the worker using the selected mode of communication.

This invention relates to a device operable to provide details of a worker's whereabouts when he is away from his usual desk or workplace, and which also enables co-workers or visitors to make contact with the worker in his remote location.

### BACKGROUND TO THE INVENTION

Many workers spend a substantial amount of time away from their usual desk or workplace. For example, many office workers spend some of their time working from home. Others may be away from their desk travelling or visiting clients, or simply working elsewhere in the same building or site.

Accordingly, a typical occurrence in many offices is that someone visits a worker's workplace and discovers that the person they sought to visit is not there. Often the worker has not left any details of their whereabouts. Sometimes people who know they are going to be away from their desk have the foresight to leave a note on a piece of paper or a message on a nearby whiteboard, but these can easily be overlooked or removed.

Some offices have shared on-line calendars on their computers, which may provide details of absent people's whereabouts. However, in order to find out if such details have been provided, the visitor would have to go back to their own desk and access their computer (assuming they work for the same company). If the visitor is from elsewhere, then they are unlikely to be able to view information in a shared on-line calendar, unless the absent worker's colleagues are able to assist. Of course, there is no guarantee that the absent worker has supplied details of their whereabouts in any case, and so time spent trying to access an on-line calendar may be wasted.

It may be possible for the visitor to ask the remote worker's colleagues if they know the worker's whereabouts, but this interrupts the worker's colleagues and they may be unable to help in any case.

Sometimes people do not know in advance that they are going to be away (e.g. because of illness or an unexpected secondment elsewhere) and therefore have not been able to leave any kind of information whatsoever.

Remote workers often do not provide details in their workplace of how they may be contacted in their remote location. It is quite possible that a visitor at the worker's desk might discover that the worker is working from home that day, but no contact details are provided and so the visitor is unable to contact the worker. Alternatively, a plurality of contact details (e.g. home phone, mobile phone, e-mail, fax, pager etc.) for the remote worker may be known, but it might not be clear which method of communication would be preferable, or if it would be convenient for the remote worker to be contacted at that time.

A further problem experienced by many homeworkers and the like is that when they are working away from the office they feel they have little presence actually in the office. Colleagues sometimes doubt they are actually working at all, or question their contribution to team projects. This can be detrimental to the remote worker's career progress.

It is a general object of the present invention to overcome or at least mitigate at least some of the problems, shortcomings and disadvantages identified above.

### SUMMARY OF THE INVENTION

According to the present invention there is provided a device for positioning in the workplace of a worker, the device being operable, in the worker's absence from said workplace, to provide a visitor to the workplace with information specifying the remote location of the worker and to enable the visitor to communicate with the absent worker; the device comprising (preferably in a common housing) processing means, memory, a digital display and a user interface; the processing means being coupled to a database, the database comprising data representative of a remote location and corresponding data representative of at least one possible mode of communication between the device and the remote worker at the said remote location; the processing means being electrically coupled to the digital display and the user interface; the memory being operable to store data specifying the remote location of the worker; the digital display being operable to display information specifying the remote location of the worker; the processing means being operable to interrogate the database to obtain the possible modes of communication corresponding to the said specified remote location of the worker, and then to cause the said modes of communication to be displayed for selection by the visitor; the user interface being operable to enable a visitor to select a mode of communication; and the processing means being configured to effect communication with the worker using the selected mode of communication.

This device enables visitors to the worker's workplace (office, cubicle, desk area etc.) to learn for themselves where the remote worker currently is, and advantageously enables contact to be made with the remote worker.

With communication by telephone, the contact telephone number(s) need not be displayed. Instead, the user-selectable regions may simply be identified as being “mobile phone”, “home phone” etc., and the processing means cause the appropriate number to be dialled depending on which user-selectable region is chosen by the visitor.

Preferably the device is wall-mountable. This advantageously means that the device does not take up valuable desk space, and enables it to be hung in a prominent position so that visitors can interact with it at eye level whilst standing.

Preferably the processing means are configured such that the data specifying the remote location of the worker may be remotely edited via a communications network. This enables the remote worker to update the information as required, without needing to return to his office or workplace to do so.

In one preferred embodiment the processing means and database are operable to receive occasion-specific data from the worker specifying the modes of communication available for selection by a visitor. For example, on a given occasion, the worker may specify that he only wishes to be contacted by e-mail, and not by telephone or video link.

In an alternative preferred embodiment, available modes of communication specific to given remote locations are pre-specified and stored in the database and, in use, the processor is configured to interrogate the database to obtain the available modes of communication corresponding to the remote location specified by the worker on that occasion. For example, if the worker has specified that he is travelling, then the processing means may be configured to limit the communication options to just mobile telephone. Alternatively, if he specifies that he is working from home, then the available options may be telephone or e-mail.

Preferably the device is secure such that a visitor or unauthorised person cannot edit the data specifying the worker's remote location or the available modes of communication.

Preferably the processing means and database are configured to require a correct password to be supplied in order to enable editing of the data specifying the worker's remote location or the available modes of communication.

Preferably the device further comprises a data communications interface for communicatively connecting the device to a data communications network. This facilitates network-based communication (e.g. e-mail or network-based conferencing) between the visitor and the remote worker, and in some embodiments may also enable the worker's contact details and information specifying his location to be remotely updated.

Particularly preferably the data communications interface is adapted to receive data from a specified address only. This provides the advantage of ensuring that the data specifying the remote worker's location and his contact details, as stored in or displayed on the device, are kept secure and, in a preferred embodiment, cannot be changed by anyone other than the worker himself. The said specified address may be specified in advance by the worker, to correspond with his remote location, and may be hard coded into the device. For example, if he is working at home, then it is preferable that data transmission to the display device can only be effected from his home computer.

The data communications interface is preferably adapted to receive data over an authenticated network connection only.

Preferably the data communications interface is also adapted to transmit data to a specified address only.

Preferably the device further comprises a telephone communications interface for communicatively connecting the device to a telephone communications network, in order to enable and facilitate telephone communication between the visitor and the remote worker.

Particularly preferably the telephone communications interface comprises a subscriber identity module adapted to enable outgoing communications to be made to a specified telephone number only. This ensures that the device is only used to communicate with the remote worker as intended, and cannot be misused to call others.

Preferably the subscriber identity module is further adapted to permit incoming communications from a specified telephone number only. In one embodiment, this enables remote editing of the remote worker's details to be effected securely by telephone, e.g. using dual tone multi-frequency tones to specify the current remote location of the worker. This feature also optimises in a general sense the security of telephone communications between the device and the remote worker.

Particularly preferably the specified telephone number is hard coded into the device. This may be permanently “burnt in” and can never be changed, or alternatively an EEPROM (electrically erasable programmable read-only memory) may be used such that the number may subsequently be changed.

Preferably the device is responsive to dual tone multi-frequency tones, said tones being interpretable to enable the remote worker to edit the data specifying the worker's remote location or the available modes of communication.

In an alternative embodiment, the processing means are configured such that the data specifying the remote location of the worker or the available modes of communication may only be edited at the device itself.

With respect to all the preferred embodiments, the possible modes of communication may be selected from a group comprising: e-mail, telephone call, video conference (also referred to herein as video link), fax.

Preferably the user interface comprises user-selectable regions corresponding to possible modes of communication with the worker.

Particularly preferably the user-selectable regions comprise buttons. These provide an intuitive and simple-to-use means by which the visitor can select a mode of communication.

Preferably the user interface comprises a touchscreen area. This may provide the user-selectable regions mentioned above, or may supplement them by providing an additional user input area.

Particularly preferably the touchscreen area is operable to receive hand-written input from the visitor for transmission to the worker. The device may further comprise a tethered stylus for use in writing on the touchscreen. The hand-written input may be transmitted to the remote worker as a graphics file, or alternatively (in a less-preferred embodiment) in a text file generated using a character recognition algorithm.

The device may also comprise a variety of communication devices to enable the visitor to communicate with the remote worker. For example, the device may further comprise a microphone, a speaker (which may be an earpiece so as not to disturb people nearby), a telephone handset or a video camera (to enable video conferencing between the visitor and the remote worker).

Preferably the device is configured to display a video image of the worker working in his remote location. This advantageously enables the remote worker's colleagues to verify that the worker is actually working, and helps to maintain the worker's presence in the workplace. It also enables visitors to see if it would be convenient for the remote worker to be contacted by them at that point, or if the remote worker is pre-occupied (e.g. in a meeting with others) and thus should not be disturbed.

In a preferred embodiment the device is also adapted to synchronise with calendar software on the remote worker's computer and thereby automatically update the information specifying the remote location of the worker. This advantageously enables the information displayed on the device to be kept up to date, without requiring direct input from the worker.

### BRIEF DESCRIPTION OF THE DRAWINGS

Embodiments of the invention will now be described, by way of example, and with reference to the drawings in which:

FIG. 1 illustrates a front view of a wall-mountable display device in accordance with embodiments of the invention;

FIG. 2 illustrates an example of a network in which a display device is connected, via a network interface, to a local intranet and an external network; and

FIG. 3 shows an illustrative example of a database array relating the remote worker's contact coordinates with his specified location and the available modes of communication.

### DETAILED DESCRIPTION OF PREFERRED EMBODIMENTS

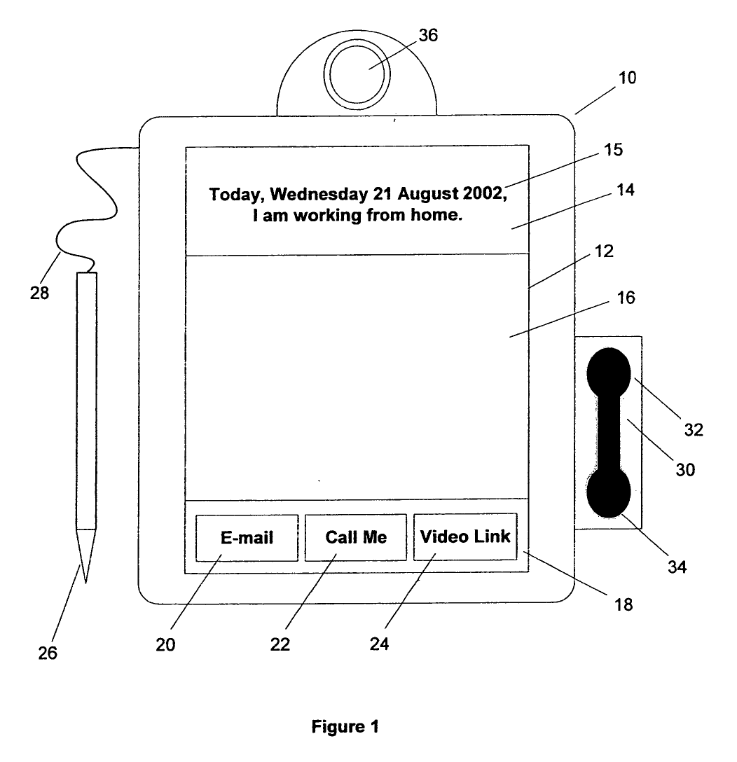

FIG. 1 illustrates a display device 10 in accordance with embodiments of the invention. In use, the device is situated in the usual workplace (e.g. office) of a worker. The device is substantially the size of a conventional calendar. Wall hanging means (not illustrated), such as those employed to hang a picture, may be provided on the rear of the device 10 to enable it to be hung on a wall. Alternatively, stabilising feet or a stand may be provided to enable it to be stood on a desk or tabletop. The device enables visitors to the workplace to learn the whereabouts of the absent worker, and to enable communication with him, if circumstances permit.

The display device 10 is used when the worker is absent from his usual workplace—for example, because he is working from home or is travelling on business. The display device 10 comprises a first display area 14 (termed the “status area”) which displays information 15 specifying the remote location of the worker, a second touch-sensitive display area 16 (termed the “message area”) in which the visitor may leave a written message using the tethered stylus 26, connected to the display device 10 by a cord or cable 28. Also provided is a user interface area 18 comprising communication options 20, 22, 24 with which the visitor may effect communication with the remote worker. These communication options 20, 22, 24 may be buttons, or touch-responsive areas on a touch screen. Indeed, the entire area 12 encompassing the first 14 and second 16 display areas and the user interface area 18 may comprise a single display panel, being touch-sensitive in areas 16 and 18 at least.

Optionally, a video camera 36 may also be provided, to enable video conferencing between the visitor and the remote worker. Alternatively, or in addition, a telephone handset 30 may be provided, having a microphone 34 and a speaker 32, to enable the visitor to conduct a telephone conversation with the worker. It will be appreciated that the microphone 34 and speaker 32 need not be provided in a handset, but may be incorporated in the body of the display panel, or elsewhere, to achieve an equivalent effect.

The display device also comprises a data communications interface, enabling it to be connected to a data communications network over which it can transmit and receive data, and a telephone communications interface to enable telephone calls to be made using the telephone apparatus mentioned above.

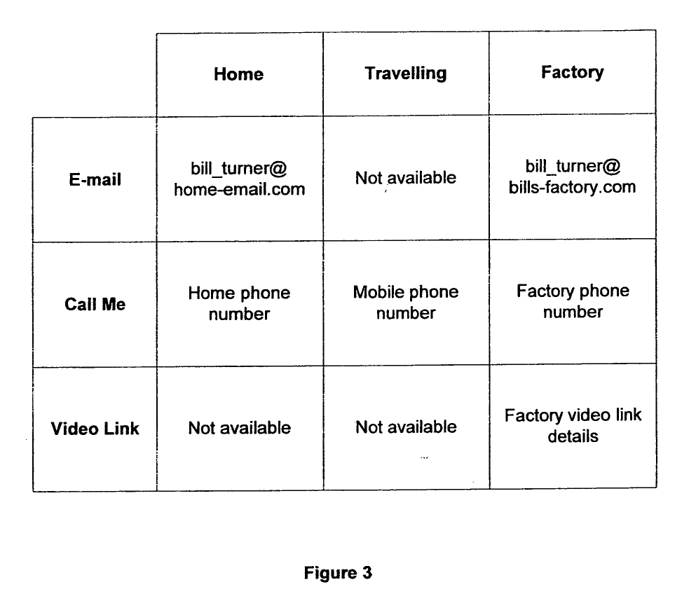

Internally, the display device comprises a processor, memory and other electronic components as will be understood by those skilled in the art. The processor is connected to a database, which may be within the device itself or remote from of it (e.g. connected via a data communications connection or a network). The database stores data representative of the worker's remote location(s) and corresponding data representative of the possible modes of communication between the device and the remote worker at the each of the remote locations. Possible modes of communication are, for example, mobile telephone, home telephone, e-mail and video link. For each mode of communication for each remote location, the database also stores the necessary contact coordinates (e.g. the telephone number or e-mail address). An illustrative example of a database array relating the worker's contact coordinates with the specified location and the different modes of communication is shown in FIG. 3.

The display device may be integrated with electronic calendar software (e.g. Microsoft (RTM) Outlook (RTM)) running on a conventional PC, and it is envisaged that such software may be supplied together with the display device.

In use, the device's processor receives input specifying the remote location of the worker on a given day. This input may come directly from the worker, or from electronic calendar software running on his PC. Once the processor has received this input, it interrogates the database to obtain the available modes of communication corresponding to the specified remote location. These modes of communication are then displayed as the communication options 20, 22, 24 in the user interface area 18.

In one embodiment, the remote worker may specify occasion-specific modes of communication to be made available to visitors, and these are then stored in the database to be subsequently access by the processor and displayed as described above. For example, if the remote worker is working at home, he may specify that visitors may contact him by e-mail, telephone or video link (as shown in FIG. 1). Alternatively, if he is travelling, only the telephone option may be specified by the worker to be available for use by visitors, and the other options may be “greyed out” or hidden from view.

In a second embodiment, the database may be pre-configured (either at the time of manufacture or, more likely, subsequently by the user) to associate specific modes of communication with specific remote locations. For example, the device may be configured to associate e-mail, telephone and video link with the location of the worker's home. Mobile telephone alone may be associated with travelling. In use, therefore, the processor receives input specifying the worker's remote location and then interrogates the database to obtain the pre-specified location-specific available modes of communication. These are then displayed for selection by visitors.

When a visitor selects a mode of communication by pressing on the desired communication option button (e.g. 20, 22 or 24), the processor automatically effects the chosen mode of communication between the visitor and the remote worker.

The features outlined above, and their functionality, will now be described in greater detail.

### The Status Area (14)

The status area 14, which displays the remote worker's current location, may be programmed in advance by the worker at the display device itself (i.e. before he leaves his office), or remotely via a secure connection (which will be described in greater detail later).

Alternatively, the display device may be synchronised with the worker's electronic calendar/diary software (e.g. Microsoft (RTM) Outlook (RTM)), which may be running on a PC connected directly to the display device, or indirectly via a network. Accordingly, for any given day on which the worker is away from his office, the display device can be set to reproduce the text from the electronic calendar for that day. The text from the electronic calendar may be overwritten by the user if desired.

### The Message Area (16)

The message area 16 comprises a touch screen on which visitors can leave a message for the remote worker. The message may be left in a variety of different ways. The currently preferred manner by which a message may be left involves the visitor writing or drawing directly onto the touch screen using the tethered stylus 26. The message and drawings is then encoded as a graphics file (e.g. a .jpg file) which is then transmitted electronically (e.g. by e-mail) to the remote worker.

Alternatively, and currently less preferably, the message area may display a representation of a keyboard, and the visitor may touch on the representations of the keys in order to spell words and thereby compose a message. This message may then be transmitted as a text data file to the remote worker. Yet a further alternative by which a message may be composed involves the visitor writing on the touch screen, and then the display panel's processor performing character recognition on the written characters to convert them to a text data file. However, the transmission of the message as a graphics file is preferred over these latter two alternatives, as it provides greater flexibility and freedom to the visitor, enabling him to leave sketches and diagrams as well as text.

As a further alternative, the visitor may write a message in the message area, and leave the message for the worker to view on his return to the office. Here, the message is not sent to the worker, but either remains in view in the message area or is stored in the device's memory and hidden from view. In the latter case, to retrieve stored messages, the worker may be required to identify himself to the device, e.g. by supplying a password.

The message area may also be configured to display an image of the worker working in his remote location. This image of the worker may be transmitted substantially live from the worker's remote location using a webcam or equivalent means, and may be updated as frequently as circumstances permit. Preferably a moving video image is displayed. Displaying this image of the worker working provides the advantage that visitors can see what he is doing, and whether it would be convenient to contact him. The remote worker thereby maintains a presence in the office, even when working elsewhere.

When the device 10 is being used for video conferencing between the visitor and the remote worker, the message area 16 may be used to display substantially live images of the remote worker.

### The User Interface Area (18)

The user interface area 18 comprises a plurality of user-selectable regions 20, 22, 24 corresponding to different available modes of communication by which the visitor may make contact with the remote worker. These regions may be touch-sensitive regions on a display panel, or conventional buttons. The available modes of communication will depend on the worker's remote location. Given the location, the processor interrogates the database to obtain the corresponding modes of communication, which are then presented by the processor in the user interface area 18 for selection by a visitor. When a visitor selects a region (e.g. by pressing on it), the device's processor is configured to effect the specified mode of communication between the visitor and the remote worker.

If the user-selectable regions 20, 22, 24 are regions of a touch-sensitive display panel, then the processor may be programmed to display appropriate captions in the said regions (as illustrated in FIG. 1), to change the number of user-selectable regions displayed, or to “grey out” regions which are not available for selection.

Alternatively, if the user-selectable regions 20, 22, 24 are conventional buttons, they may be labelled as shown in FIG. 1. Each button may incorporate a light, which would be illuminated if the corresponding mode of communication is available, or turned off if it is unavailable.

With conventional buttons or regions of a touch-sensitive display panel, there is no requirement for the user-selectable regions to display the remote worker's telephone number or e-mail address. Indeed, in a preferred embodiment of the device, these details are not displayed, and instead the user-selectable regions simply make reference to the available modes of communication (as shown in FIG. 1).

Examples of possible modes of communication will now be discussed in greater detail:

### E-Mail (20)

Touching the e-mail “button” 20 causes a prompt to be displayed on the display device, inviting the visitor to write a message on the touchscreen 16. In a preferred embodiment, the message is then sent as a graphics file by e-mail (e.g. as an e-mail attachment) to the remote worker, to an e-mail address specified by the remote worker beforehand and stored in the database. The touchscreen may display “send” and “cancel” touch-buttons, for the visitor to cause their message to be transmitted or cancelled.

### Call Me (22)

When a visitor touches the Call Me “button” 22, the device 10 makes a telephone call to the remote worker, using a telephone number specified in advance by the worker and stored in the database. The number could be the worker's home telephone number or his mobile number, depending on the worker's location. The number itself is not displayed. As mentioned above, the appropriate location-specific telephone number (e.g. the remote worker's home phone number) is found automatically by the processor by interrogating the database, given the worker's location (e.g. home) and the available mode of communication (telephone). The visitor can then speak to the worker, e.g. using the handset 30.

### Video Link (24)

On touching the Video Link “button” 24, the device 10 establishes a video conference between the visitor and the remote worker. This may be conducted via the Internet or using other telecommunications means. The camera 36 transmits images of the visitor to the remote worker, and audio may be captured via the microphone 34 in the handset 30, or by an alternative microphone device. Images of the remote worker are displayed in the message area 16, and audio from the remote worker may be reproduced using a built-in speaker (not illustrated), an earpiece or the speaker 32 in the telephone handset 30.

The above modes of communication should not be considered to be an exhaustive list, and other options are possible, which would also be stored in the database. For example, the message provided by the visitor may be transmitted by fax or pager to the remote worker. If these are available options, then corresponding Fax or Pager “buttons” would be provided in the user interface area 18.

### Displaying Information Sent From the Remote Worker

The remote worker may send information to the display device, for example using a remote PC or a TouchTone (RTM) phone. In the latter case, the display device would be pre-configured to respond to certain TouchTone sequences, and the remote worker would be given audible instructions such as “Press 1 for display options; press 2 to change the greeting or location” etc. Using either a PC or a TouchTone phone, the remote worker may thereby provide details of his location (e.g. home or travelling), available modes of communication, and optionally the availability status of the worker (e.g. “I am working—do not disturb me” or “I am free to take calls”). Changes in the worker's remote location would be displayed in the status area 14. Other messages to be viewed by visitors to the display device may also be transmitted, to be displayed in the message area 16. For security, a password (when using a PC) or a personal identification number (when using a telephone) may be required in order to allow changes to be made.

### Network Connections and Security Issues

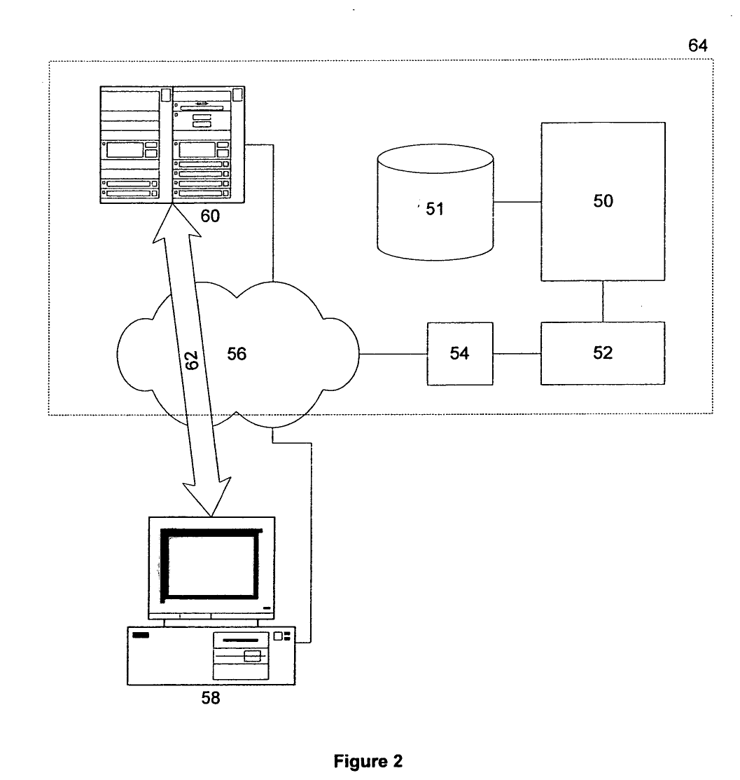

To ensure that only the owner of the display device can edit the information displayed, or specify the available modes of communication, the display device and database must be secure when connected to a network. To achieve this, a possible network configuration will now be described with reference to FIG. 2. This Figure shows a display device 50 with its database 51, connected to a network 56 via a network card 52. Also connected to the network is a secure server 60. The server 60 and the display device 50 are both within an intranet 64. The remote worker's home PC 58 is also connected to a network outside the intranet, e.g. the Internet.

To ensure that the display device 50 or database 51 may only be updated from the remote worker's PC, the network card may be configured such that it is only receptive to a single specified IP address, the single specified IP address in this case being that of the server 60. Accordingly, the remote worker can only configure the display device via the server. As shown in FIG. 2, the server 60 is configured to establish a secure connection 62 (i.e. a “tunnel”) with the remote PC 58. This may be achieved using a secure sockets layer (SSL) protocol, or preferably a transport layer security (TLS) protocol.

Security is also an important consideration when transmitting information from the display device 50 to the remote PC 58. This may be achieved by configuring the network card 52 such that it only transmits data to a specified IP address, which again may be that of the secure server 60 (e.g. an e-mail server).

The security of telephone communication to and from the display device is also a key issue. It is important that visitors who use the device should be unable to use it to call anyone other than the remote worker. Moreover, if the remote worker uses a dual tone multi-frequency (TouchTone (RTM)) protocol to update information in the database 51, then it is important that the display device should only be receptive to incoming communications from a single specified telephone number. To address these requirements, a specially adapted subscriber identity module 54 may also be connected to the display device 50. This subscriber identity module 54 is configured such that it can only make outgoing calls to a single specified number, and is only receptive to calls from a single specified number. This number may be programmed once and “burnt in” such that it can never be changed. The rest of the memory of the subscriber identity module may be “burnt out” so that additional numbers cannot be added.

Alternatively, instead of using a customised subscriber identity module, a PROM (a programmable read-only memory) chip may be used instead. A PROM chip is similar to an EPROM (erasable programmable read-only memory) chip, but is adapted such that it cannot be reconfigured.

As a further alternative, an EEPROM (electrically erasable programmable read-only memory) may be used, which would store both the remote worker's contact telephone number and his single specified IP address, and would allow either to be changed, but only after a correct password has first been supplied. Preferably, the owner's physical presence at the display device would also be required, although remote updates are also possible in principle.

As an additional security measure, the display device may be configured such the details of the remote worker's location or modes of communication may only be edited relatively infrequently—e.g. no more frequently than once every 30 minutes.

### Examples of the Display Panel in Use

Examples illustrating the use of the display panel will now be described with reference to FIGS. 1, 2 and 3.

A display panel 10 is owned by Bill Turner, who usually works in an office. The display panel is mounted on his office wall. Today he is at home, and he has already remotely updated his location on his display panel using his home PC 58 (FIG. 2), using the technique previously described with reference to FIG. 2. Bill's new location is displayed in a message 15 (FIG. 1) in the status area 14 of the display device 10. Effectively simultaneously, the display device's processor interrogates the associated database 51 (FIG. 2) and (with reference to the array in FIG. 3) determines that communication with Bill at home is possible via e-mail and telephone, but not by video link. Accordingly, the processor assigns Bill's home e-mail address to the “E-mail” button 20, his home telephone number to the “Call Me” button 22, and greys out the “Video Link” button 24 since this mode of communication is not available when he is at home.

A visitor to Bill's office discovers that he is not there, but on seeing the display device 10, the message 15 and the available communication buttons 20 and 22, the visitor decides to contact Bill at home. She presses the “Call Me” button 22, the display device automatically dials Bill's home phone number, and she can then talk to him using the telephone handset 30.

Later that day, Bill is called to an unexpected problem at his company's factory site. Before leaving home, he uses his home PC to update his location to “travelling”. This change in location is reflected in an updated message 15 on the display device, which now reads “I am travelling”. The database (see FIG. 3) is again interrogated by the processor, and accordingly both the “E-mail” and “Video Link” buttons are greyed out, and Bill's mobile phone number is assigned to the “Call Me” button 22. Whilst he is in his car, a second visitor arrives at his office and wishes to call him. She sees that “Call Me” is now the only available option, and by pressing it the display device 10 automatically calls Bill's mobile phone number.

When Bill arrives at the factory, he uses a TouchTone (RTM) phone to remotely supply a personal identification number to his display device, and then enters a further sequence of TouchTone (RTM) tones to change his location to “Factory”. The processor interrogates the database and assigns all three communications buttons 20, 24, 26 with the appropriate coordinates (FIG. 3). Later, another visitor arrives at Bill's office and wishes to send him a sketch of a new product she has invented. The visitor uses the stylus 26 to draw her sketch onto the touch panel in the message area 16, and then presses the “E-mail” button 20. The processor converts the sketch into a graphics file, attaches it to an e-mail message and sends it to Bill at his factory e-mail address, as specified in the database array.

1. A device for positioning in the workplace of a worker, the device being operable, in the worker's absence from said workplace, to provide a visitor to the workplace with information specifying the remote location of the worker and to enable the visitor to communicate with the absent worker;
the device comprising processing means, a display and a user interface;
the processing means being adapted to access a database holding data representative of a remote location and corresponding data representative of at least one possible mode of communication between the device and the remote worker at the said remote location;
the processing means being electrically coupled to the digital display and the user interface;
the display being operable to display information specifying the remote location of the worker;
the processing means being operable to interrogate the database to obtain the possible modes of communication corresponding to the said specified remote location of the worker, and then to cause the said modes of communication to be displayed for selection by the visitor;
the user interface being operable to enable a visitor to select a mode of communication;
and the processing means being configured to effect communication with the worker using the selected mode of communication.

2. A device as claimed in claim 1, wherein the processing means are configured such that the data specifying the remote location of the worker may be remotely edited via a communications network.

3. A device as claimed in any preceding claim, wherein the processing means and database are operable to receive occasion-specific data from the worker specifying the modes of communication available for selection by a visitor.

4. A device as claimed in any preceding claim, wherein available modes of communication specific to given remote locations are pre-specified and stored in the database and, in use, the processor is configured to interrogate the database to obtain the available modes of communication corresponding to the remote location specified by the worker on that occasion.

5. A device as claimed in any of claims 1 to 4, being secure such that a visitor or unauthorised person cannot edit the data specifying the worker's remote location or the available modes of communication.

6. A device as claimed in any preceding claim, wherein the processing means and database are configured to require a correct password to be supplied in order to enable editing of the data specifying the worker's remote location or the available modes of communication.

7. A device as claimed in any preceding claim, further comprising a data communications interface for communicatively connecting the device to a data communications network.

8. A device as claimed in claim 7, wherein the data communications interface is adapted to receive data from a specified address only.

9. A device as claimed in claim 7 or claim 8, wherein the data communications interface is adapted to receive data over an authenticated network connection only.

10. A device as claimed in claim 8 or claim 9, wherein the data communications interface is adapted to transmit data to a specified address only.

11. A device as claimed in claim 8 or claim 10, wherein the specified address is hard coded into the device.

12. A device as claimed in any preceding claim, further comprising a telephone communications interface for communicatively connecting the device to a telephone communications network.

13. A device as claimed in claim 12, wherein the telephone communications interface comprises a subscriber identity module adapted to enable outgoing communications to be made to a specified telephone number only.

14. A device as claimed in claim 13, wherein the subscriber identity module is further adapted to permit incoming communications from a specified telephone number only.

15. A device as claimed in any of claims 12 to 14, wherein the specified telephone number is hard coded into the device.

16. A device as claimed in any of claims 12 to 15, being responsive to dual tone multi-frequency tones, said tones being interpretable to enable the remote worker to edit the data specifying the worker's remote location or the available modes of communication.

17. A device as claimed in claim 1, wherein the processing means are configured such that the data specifying the remote location of the worker or the available modes of communication may only be edited at the device itself.

18. A device as claimed in any preceding claim, wherein the possible modes of communication are selected from a group comprising: e-mail, telephone call, video conference, fax.

19. A device as claimed in any preceding claim, wherein the user interface comprises user-selectable regions corresponding to possible modes of communication with the worker.

20. A device as claimed in claim 19, wherein the user-selectable regions comprise buttons.

21. A device as claimed in any preceding claim, wherein the user interface comprises a touchscreen area.

22. A device as claimed in claim 21, wherein the touchscreen area is operable to receive hand-written input from the visitor for transmission to the worker.

23. A device as claimed in any preceding claim further comprising a communication device selected from a group comprising: a microphone, a speaker, a telephone handset, a video camera.

24. A device as claimed in any preceding claim, configured to display a video image of the worker working in his remote location.

25. A device as claimed in any preceding claim, adapted to synchronise with calendar software on the remote worker's computer and thereby automatically update the information specifying the remote location of the worker.

26. A device substantially as hereinbefore described with reference to the accompanying drawings.
